(19) United States
(12) Patent Application Publication
(10) Pub. No.: US 2013/0019410 A1
(43) Pub. Date: Jan. 24, 2013

(54) SYSTEMS AND METHODS FOR PROVIDING A PROTECTIVE GUARD FOR FURNITURE LEGS

(71) Applicant: Julie Willis, Olympia, WA (US)

(72) Inventor: Julie Willis, Olympia, WA (US)

(21) Appl. No.: 13/187,102

(22) Filed: Jul. 20, 2011

(51) Int. Cl. A47C 21/00; A47B 91/04; B23P 11/00; A47B 91/12

(52) U.S. Cl. 5/663; 248/346.5; 29/428

(57) ABSTRACT

A protective guard for furniture legs, particularly bed legs, to lessen the impact when a person inadvertently rams a toe or other part of the foot into the furniture leg. A protective guard for furniture legs includes a base on which a furniture leg rests, and a cushion which covers at least a portion of the furniture leg. The base can be circular and the cushion cylindrical, so the base and cushion couple at the bottom of the cushion, giving the protective guard the form of a cup. The device can be made of foam, providing the cushioning aspect and lessening the impact when a toe or other part of the foot strikes a leg of furniture, and protecting the surface on which the furniture rests. The device can be decorative, providing an enhanced visual appeal to a wheel of a bed frame or other portion of a furniture leg.

### BACKGROUND

A hidden danger lurks in the bedroom. The legs or posts on which the frame of a bed rest, typically somewhat camouflaged or hidden by sheets or blankets hanging from the top of the bed, present a solid obstacle on which many toes have been stubbed over the centuries. Particularly while making a bed with fresh sheets, when one approaches the bed near its corners and leans over it to wrap a fitted sheet around a corner of the mattress, one is especially likely to inadvertently stub a toe on the wheel or leg of the bed frame.

Nearly everyone has had the experience of a toe or foot injury from a bed leg, ranging from a few seconds of mild discomfort to prolonged extreme pain or serious injury. Such an injury could include soft tissue damage, or even a broken toe or other foot bone. This is so commonplace that there is even a Facebook page for those who have suffered this experience (Internet website address is www.facebook.com/pages/Hating-when-you-stub-your-toe-especially-on-the-edge-of-the-bed/244751389203). And in 2008, People Magazine documented a foot injury to actress Mary-Louise Parker, who “smashed [her foot] on the bed frame,” breaking her toe (Internet website address is www.people.com/people/article/0,,20206859,00.html). Some unlucky individuals stub their toes even on legs of furniture that are not obscured by bedding, like dressers or end tables.

What is needed is a protective guard device for furniture legs, to absorb the impact felt when one inadvertently rams a toe or other part of the foot into the leg of the furniture, and to prevent injuries to toes and feet. Other benefits of such a protective guard device could include the prevention of scratches or other damage to the floor upon which the furniture sits, or preventing a bed from moving or rolling about the floor.

In addition, a protective guard device for a leg or wheel of a bed frame or other piece of furniture could be decorated. A pattern or other design on the exterior of the device could provide a pleasing visual appearance and enhance visual appeal if, for example, the leg of the bed furniture itself is not completely obscured by sheets, blankets or other bedding.

Accordingly, this application discloses systems and methods for providing a protective guard device for furniture legs.

### FIELD OF THE INVENTION

This invention relates generally to protective guards, and more specifically, to a protective guard device for furniture legs.

### SUMMARY

The invention relates generally to protective guards, and more specifically, to a protective guard device for furniture legs. In some embodiments, a protective guard for furniture legs includes at least two components: a base on which a furniture leg rests, and a cushion covering at least a portion of the furniture leg. In some embodiments, a base is laid on the floor or other surface on which the furniture rests, such that the top surface can receive at least a portion of a leg of a piece of furniture. In this embodiment, a cushion is positioned to cover at least a portion of the leg of a piece of furniture. In this embodiment, the furniture leg is disposed through a hollow portion of a cushion described by the inside surface of a cushion.

In some embodiments, after a furniture leg is disposed through a cushion and the furniture leg is received by a base, a base receives a cushion. In one embodiment, a cushion can encircle a base at a bottom portion of the cushion and the side wall of the base, forming a joint between the cushion and the base. In a further embodiment, the joint is formed permanently with glue or other adhesive, such that the embodiment of the base and cushion joined permanently at the joint takes on the form of a cup. In some embodiments, a protective guard for a furniture leg is made of foam. In some embodiments, a cushion or a base may include exterior surfaces and an interior filling, such as sand or other filler.

In some embodiments, a protective guard for furniture legs is used with a bed frame having a bed leg with a wheel or glide at a base of the bed leg. In different embodiments, a protective guard for furniture legs is used with a piece of furniture that has neither a wheel, nor a glide, nor any other apparatus at the base of the leg. In some embodiments, a protective guard for furniture legs can prevent scratches or other damage of the surface on which the furniture is placed by the leg of the furniture. In other embodiments, a protective guard for furniture legs can prevent a bed or other piece of furniture from moving about the floor or other surface on which the furniture is placed. In some embodiments, a protective guard for furniture legs is deployed on each of one or more legs of a bed or other piece of furniture.

In some embodiments, a protective guard for furniture legs has a decorative appearance or graphic design. Such a graphic design can provide a pleasing visual appeal to the protective guard for furniture legs.

In some embodiments, a cushion for a protective guard for furniture legs has an aperture, the aperture being disposed from a top edge of the cushion to the bottom edge of the cushion. In such embodiments, providing an aperture and only joining the cushion to a portion of the base provides a pull-apart function for a protective guard for furniture legs. When deploying this embodiment, a leg of a piece of furniture does not have to be raised as high off the surface on which the furniture rests in order for the embodiment to be deployed. In embodiments without an aperture in the cushion, the furniture must likely be raised at least as high as the height of the cushion. In one-piece embodiments with an aperture, a piece of furniture need only be raised slightly higher than the height of the base for this embodiment of the protective guard for furniture legs to be deployed. Provided the furniture leg is skinny enough to fit through the aperture in the cushion that is formed by pulling one or more portions of the cushion away from the base, deployment of this embodiment requires the furniture to be lifted less.

In some embodiments, a protective guard for furniture legs with an aperture has a coupling device to secure the “closure” of the one or more portions of the cushion pulled away from the base to dispose a furniture leg through the cushion. In some embodiments, the coupling device is a hook and loop type coupling device (e.g. Velcro® brand hook and loop fasteners).

In a different embodiment, a method for providing a protective guard for furniture legs is disclosed. The method includes lifting a corner of a piece of furniture, thereby separating a leg of the piece of furniture from a surface on which the furniture rests; deploying a cushion of a furniture leg protective guard device, thereby covering at least a portion of the leg of the piece of furniture with the cushion; placing a base of a furniture leg protective guard device underneath the leg of the piece of furniture; and lowering the corner of the piece of furniture, thereby resting the leg of the piece of furniture on the base of the furniture leg protective guard device.

### BRIEF DESCRIPTION OF THE DRAWINGS

Embodiments of the present invention are described in detail below with reference to the following drawings:

FIG. 1 is a perspective view of a foot of a person smashing into a wheel of a leg of a piece of furniture, in this case a bed;

FIG. 2 is a perspective view of a protective guard for furniture legs, in accordance with an embodiment of the invention;

FIG. 3 is a top view of a protective guard for furniture legs, in accordance with an embodiment of the invention;

FIG. 4 is a side view of a protective guard for furniture legs, in accordance with an embodiment of the invention;

FIG. 5 is an exploded view of a protective guard for furniture legs in deployment on a leg of a piece of furniture, in accordance with an embodiment of the invention;

FIG. 6 is an exploded view of a protective guard for furniture legs in deployment on a leg of a piece of furniture, in accordance with an embodiment of the invention;

FIG. 7 is an exploded view of a protective guard for furniture legs in deployment on a leg of a piece of furniture, in accordance with an embodiment of the invention;

FIG. 8 is an exploded view of a protective guard for furniture legs in deployment on a leg of a piece of furniture, in accordance with an embodiment of the invention;

FIG. 9 is a perspective view of protective guards for furniture legs in deployment on one or more legs of a piece of furniture, in accordance with an embodiment of the invention;

FIG. 10 is a perspective view of protective guards for furniture legs in deployment on one or more legs of a piece of furniture, in accordance with an embodiment of the invention;

FIG. 11 is a perspective view of a foot of a person smashing into a leg of a piece of furniture on which a protective guard for furniture legs has been deployed, in accordance with an embodiment of the invention;

FIG. 12 is a perspective view of a protective guard for furniture legs, in accordance with an embodiment of the invention;

FIG. 13 is a perspective view of a protective guard for furniture legs, in accordance with an embodiment of the invention;

FIG. 14 is a perspective view of protective guards for furniture legs in deployment on a leg of a piece of furniture, in accordance with an embodiment of the invention;

FIG. 15 is a perspective view of a protective guard for furniture legs, in accordance with an embodiment of the invention;

FIG. 16 is a perspective view of a protective guard for furniture legs, in accordance with an embodiment of the invention;

FIG. 17 is a perspective view of protective guards for furniture legs in deployment on a leg of a piece of furniture, in accordance with an embodiment of the invention; and

FIG. 18 is a flow diagram of a method for providing a protective guard for furniture legs, in accordance with an embodiment of the invention.

### DETAILED DESCRIPTION

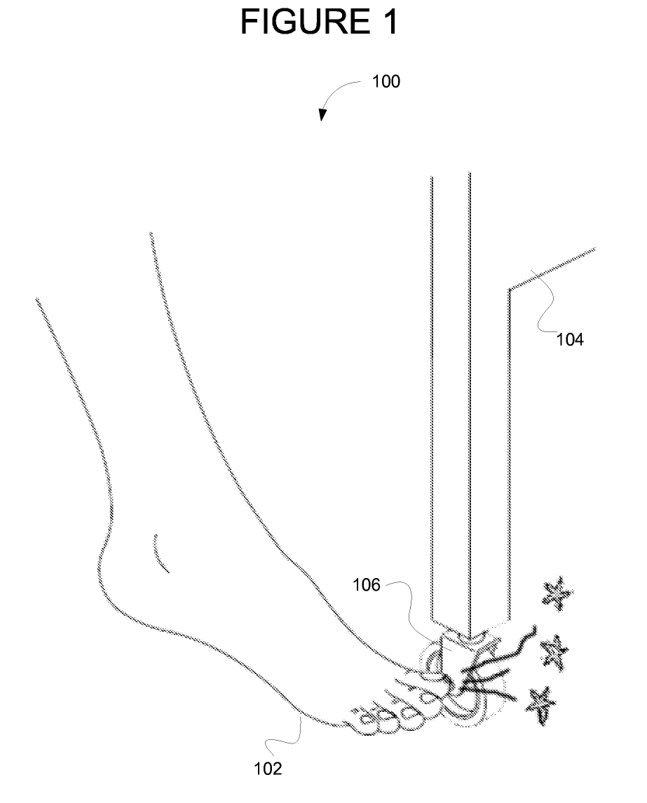

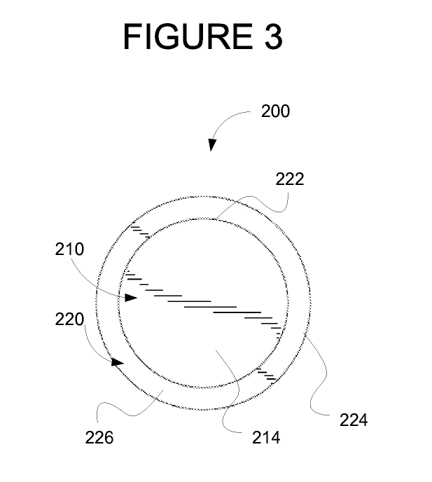

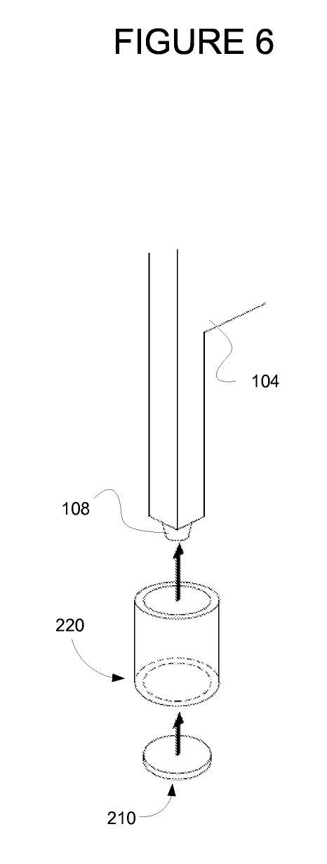

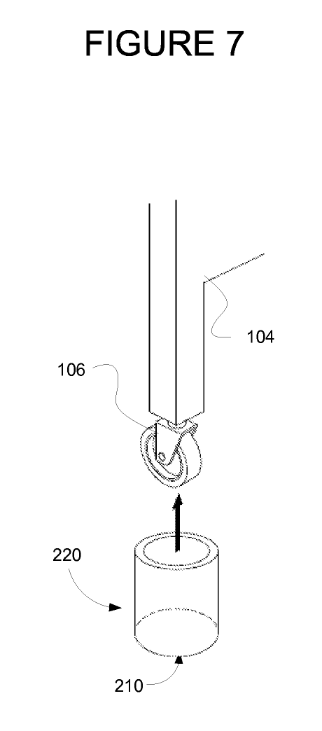

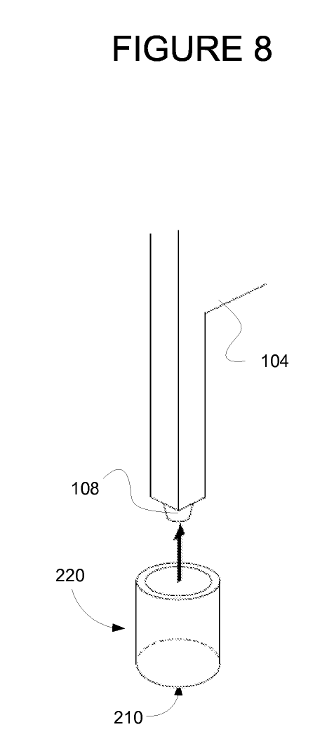

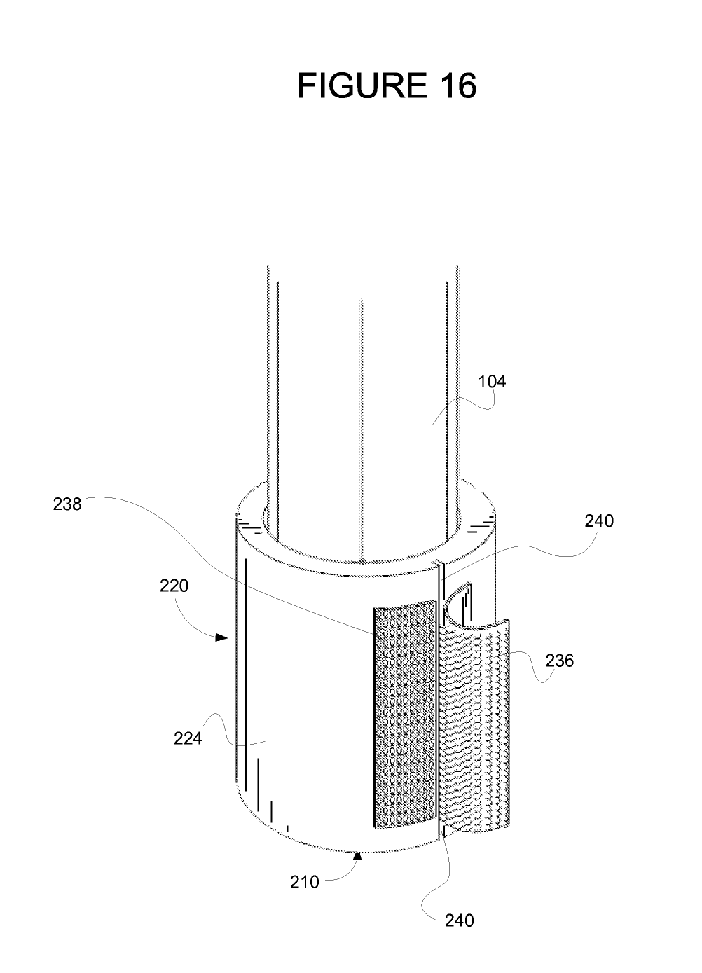

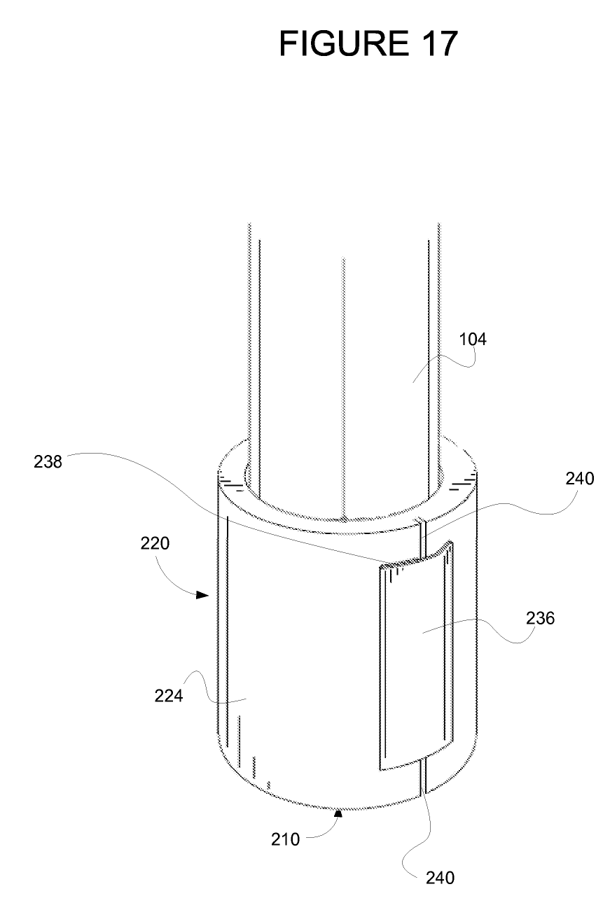

The invention relates generally to protective guards, and more specifically, to a protective guard device for furniture legs. Specific details of certain embodiments of the invention are set forth in the following description and in FIGS. 1-18 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a perspective view of a foot of a person smashing into a wheel of a leg of a piece of furniture, in this case a bed. Furniture on legs presents a hazard to the feet of those standing or moving in proximity to the furniture. A common scenario is inadvertently stubbing one's toe into the wheel or leg of a bed frame while making the bed. Other types of furniture raised on legs, such as dressers or tables, present the same hazard. The legs of furniture come in different shapes, sizes, materials, and numbers (e.g. a large dresser with six legs). Some such legs present more of a hazard than others, as in the case of a bed leg with a wheel, where the hard metal of the wheel or the bolt disposed through the wheel can actually break the skin. The present invention offers a protective guard for furniture legs and a method of deploying such a protective guard. Among the purposes of the protective guard disclosed in this application (but not the sole purpose as the instant application discloses many functions of a protective guard for furniture legs) is to cushion the impact from inadvertently ramming one's foot or toe into a bed leg, a wheel, or any other apparatus disposed at the base of a piece of furniture for the purpose of elevating the furniture from the surface on which the furniture rests. It will be appreciated by those with skill in the art that the terms “protective guard for furniture legs,” as used in the instance application including the preamble to the claims, does not limit the function of the apparatus to being a protective guard, nor does it limit its use to furniture legs. Use of the term “protective guard for furniture legs” in any claim preambles is not intended to give life, meaning, or vitality to the claims.

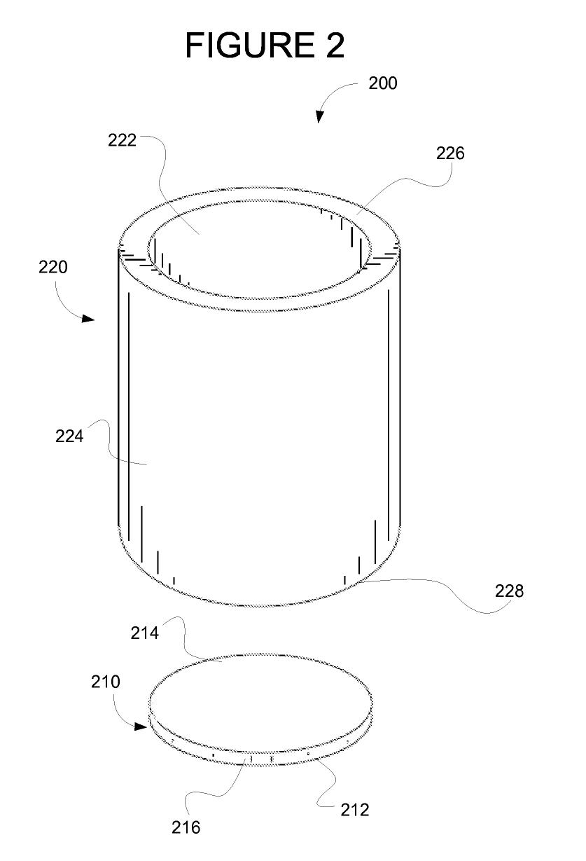

FIGS. 2, 3, and 4 are a perspective view, a top view, and a side view of a protective guard for furniture legs, in accordance with an embodiment of the invention. In some embodiments, a protective guard for furniture legs includes at least two components: a base 210 on which a furniture leg rests, and a cushion 220 covering at least a portion of the furniture leg. In some embodiments, a base 210 on which a furniture leg rests is a circular base on which a furniture leg rests, and a cushion 220 covering at least a portion of the furniture leg is a cylindrical cushion covering at least a portion of the furniture leg. In such embodiments, a base 210 on which a furniture leg rests that is circular has a bottom surface 212 that is substantially flat; a top surface 214 disposed opposite to the bottom surface 214, where the top surface 214 is also substantially flat; and a side wall 216 disposed between and along the edges of the bottom surface 212 and the top surface 214, the side wall 216 being largely cylindrical. In this embodiment, a base 210 is laid on the floor or other surface on which the furniture rests, with the bottom surface 212 disposed adjacent to the floor or surface on which the furniture rests; and the top surface 214 disposed opposite the bottom surface 212, such that the top surface 214 can receive at least a portion of a leg of a piece of furniture. In this embodiment, a cushion 220 is positioned to cover at least a portion of the leg of a piece of furniture. In this embodiment, the furniture leg is disposed through the hollow portion of a cushion 220 described by the cylindrical inside surface 222 of a cushion 220.

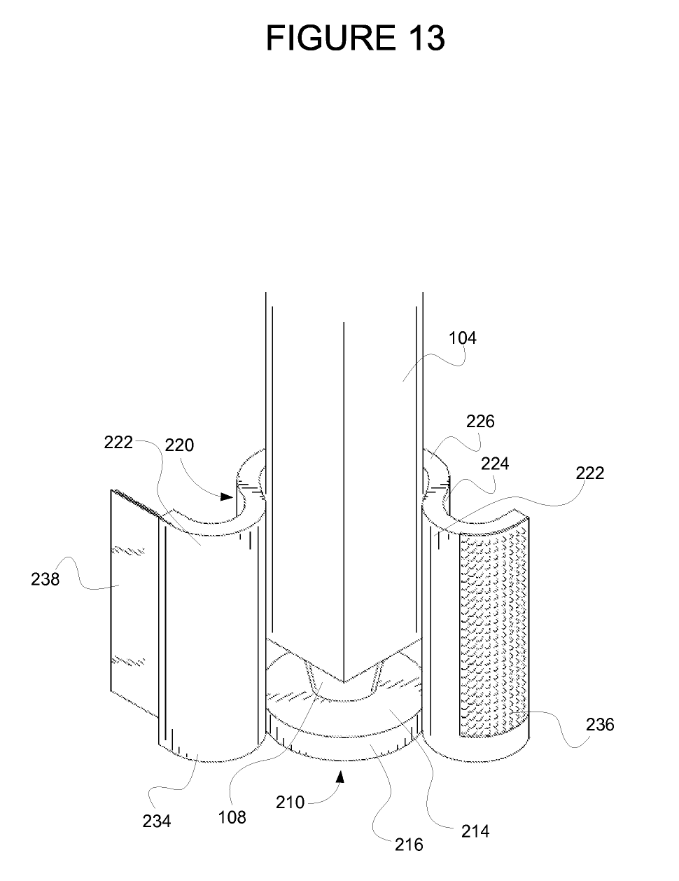

In some embodiments, after a furniture leg is disposed through a cushion 220 and the furniture leg is received by a base 210, a base 210 receives a cushion 220. In one embodiment, a cushion 220 can encircle a base 210 at a bottom portion 234 (bottom portion 234 not shown in FIGS. 2-4 but is shown in other figures e.g. FIG. 13) of the cylindrical cushion and the side wall 216 of the base 210, forming a joint 230 between the cushion 220 and the base 210. In this embodiment, the side wall 216 of base 210 is disposed adjacent to a bottom portion 234 of the cylindrical inside surface 222 of the cushion 220, such that the bottom edge 228 of the cushion 220 and the bottom surface 212 of the base 210 form a plane. In a further embodiment, the joint 230 is formed permanently with glue or other adhesive, or any other method of forming such a permanent joint, such that the embodiment of the base 210 and cushion 220 joined permanently at the joint 230 takes on the form of a cup. In such an embodiment, a protective guard for furniture legs is a one-piece design. In a different embodiment, a base 210 and a cushion 220 of a protective guard for furniture legs are melded at the same time during the manufacturing process, such that the base 210 and the cushion 220 of a protective guard for furniture legs are integrally one-piece, such that the terms “base” and “cushion” do not refer to separate components but only to different sections of the same one-piece article of manufacture.

It will be realized by those with skill in the art that a base 210 does not have to be a circular base, nor does a cushion 220 have to be a cylindrical cushion. It will be realized by those with skill in the art that a base 210 and cushion 220 with other shapes or configurations are possible that will form a protective guard for a furniture leg. It will further be realized by those with skill in the art that the combination of a base 210 and cushion 220 in different shapes other than a circle and cylinder will result in a combination with a different form than a cup.

In some embodiments, a protective guard for a furniture leg is made of foam. In other embodiments, a protective guard for a furniture leg is made of neoprene. In other embodiments, a protective guard for a furniture leg is made of a different material. In some embodiments, a base 210 on which a furniture leg rests is made of a different material than a cushion 220 covering at least a portion of the furniture leg. In a different embodiment, a base 210 on which a furniture leg rests is made of the same material than a cushion 220 covering at least a portion of the furniture leg. In some embodiments, a cushion 220 or a base 210 may include exterior surfaces and an interior filling, such as sand or other filler. In a different embodiment, a cushion 220 does not actually compress or cushion impact, and is merely a cover.

In some embodiments, a base 210 may have a thickness measured between the bottom surface 212 and the top surface 214 of approximately seven eighths of an inch. It will be recognized by those with skill in the art that other thicknesses of a base 210 are possible, ranging from thicknesses of 0.01 inches to 60 inches. In some embodiments, a cushion 220 may have a thickness measured between the inside surface 222 and the outside surface 224 of approximately seven eighths of an inch. It will be recognized by those with skill in the art that other thicknesses of a cushion 220 are possible, ranging from thicknesses of 0.1 inches to 12 inches.

In some embodiments, a base 210 may have a radius of approximately two and five eighths inches. In a further embodiment, a cushion 220 may have an interior radius of approximately two and five eighths inches. It will be recognized by those with skill in the art that the interior radius of the base 210 or the radius of the cushion 220 may vary slightly (meaning one sixteenth of an inch or less) to accommodate the joining of the base 210 with the cushion 220 at the joint 230. In some embodiments, a cushion 220 may have an exterior radius of approximately three and one half inches. It will be recognized by those with skill in the art that the radius of the base 210, as well as the interior radius and exterior radius of the cushion 220, can vary. The range could vary from an inch to sixty inches. It will also be recognized by one with skill in the art that the radius of the base 210 does not have to be smaller than the interior radius of the cushion 220. For example, it may be that in a particular embodiment, the cushion 220 “sits” on the base 210, rather than the cushion 220 encircling the base 210 as disclosed previously. In a different embodiment, the base 210 and the cushion 220 do not come into contact.

In some embodiments, a cushion 220 has a height measured from the top edge 226 of the cushion 220 to the bottom edge 228 of the cushion 220 of approximately three and one half inches. It will be appreciated by those with skill in the art that other heights of cushion 220 are possible, ranging from heights of one eighth of an inch to one hundred forty four inches.

Further, it will be recognized with skill in the art that “approximately” in the foregoing paragraphs indicates that manufacturing tolerances may be different such that a dimension of a base 220 or a cushion 220 can vary by up to five percent.

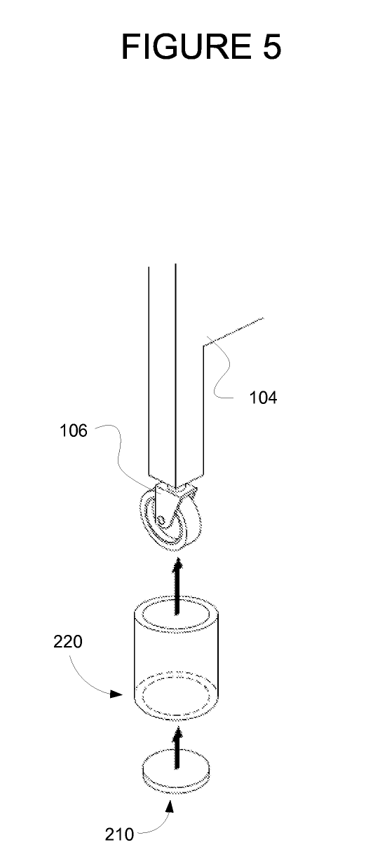

FIGS. 5, 6, 7 and 8 are exploded views of a protective guard for furniture legs in deployment on a leg of a piece of furniture, in accordance with an embodiment of the invention. In some embodiments, a protective guard for furniture legs is used with a bed frame 104 having a bed leg with a wheel 106 at a base of the bed leg. In other embodiments, a protective guard for furniture legs is used with a bed frame 104 having a glide 108 at a base of the bed leg. In different embodiments, a protective guard for furniture legs is used with a piece of furniture that has neither a wheel, a glide, nor any other apparatus at the base of the leg. In some embodiments, a protective guard for furniture legs can prevent scratches or other damage of the surface on which the furniture is placed by the leg of the furniture. In other embodiments, a protective guard for furniture legs can prevent a bed or other piece of furniture from moving about the floor or other surface on which the furniture is placed. It will be recognized by those with skill in the art that friction, surface tension, or other tensional bias between the base 210 of the protective guard for furniture legs and the surface on which the furniture rests will dampen or halt the possibility of movement of the furniture leg across the surface when the furniture leg is inserted in a protective guard for furniture legs.

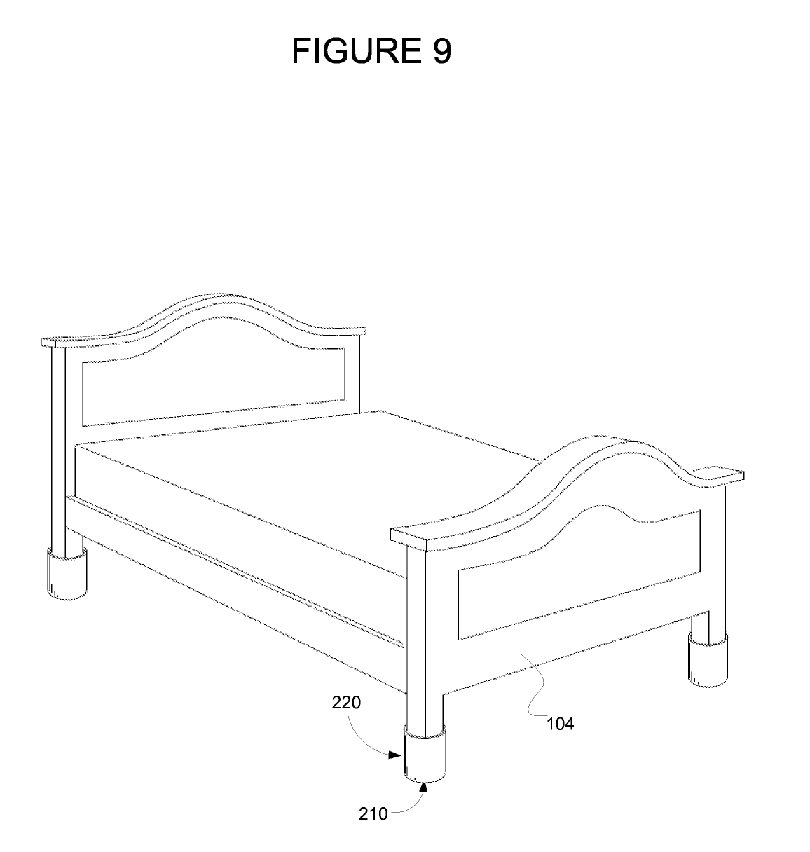

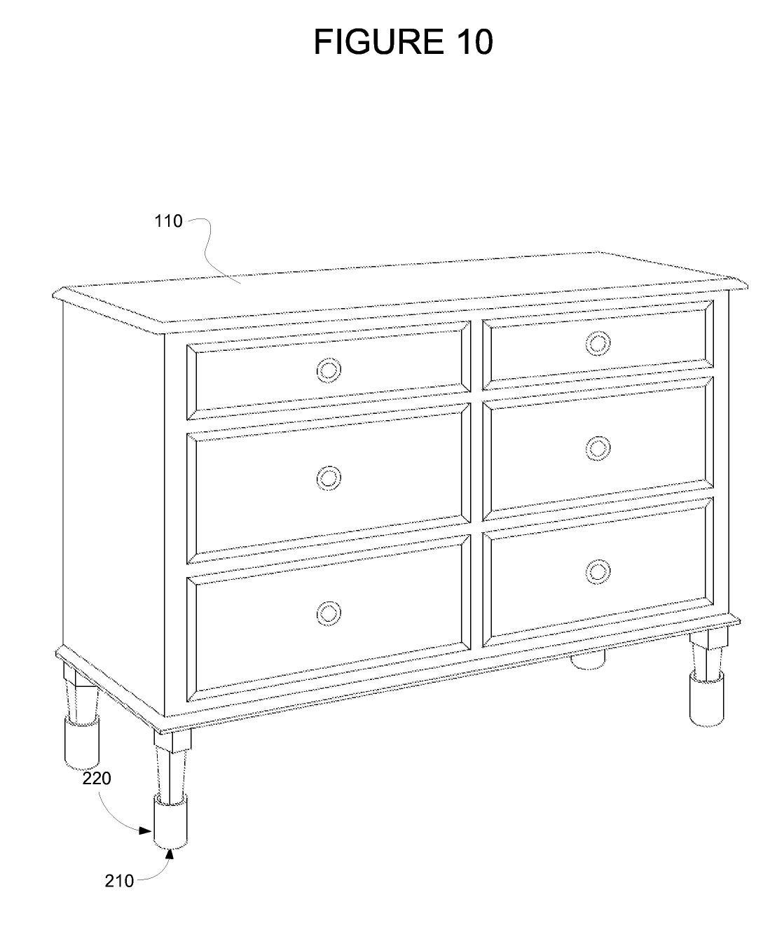

FIGS. 9 and 10 are perspective views of protective guards for furniture legs in deployment on one or more legs of a piece of furniture, in accordance with an embodiment of the invention. In some embodiments, a protective guard for furniture legs is deployed on each of one or more legs of a bed 104. In a different embodiment, a protective guard for furniture legs is deployed on each of one or more legs of a dresser 110. It will be appreciated by those with skill in the art that a protective guard for furniture legs can be used with articles other than pieces of furniture. For example, a protective guard for furniture legs could be deployed on the leg of a table saw to prevent the table saw from moving across the surface on which the table saw rests during operation of the table saw.

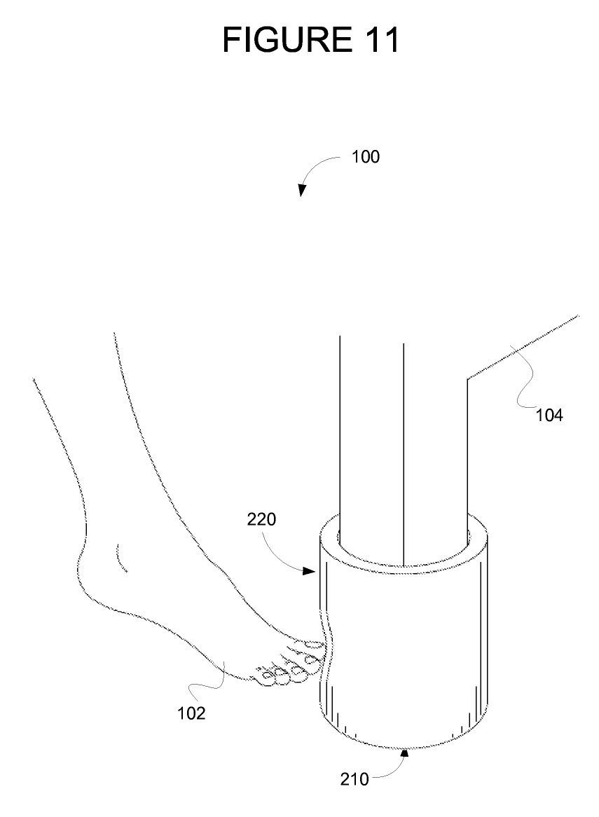

FIG. 11 is a perspective view of a foot of a person smashing into leg of a piece of furniture, in this case a bed, the bed leg having received a protective guard for furniture legs. In some embodiments, a protective guard for furniture legs cushions the impact from inadvertently ramming one's foot or toe into a bed leg, a wheel, or any other apparatus disposed at the base of a piece of furniture for the purpose of elevating the furniture from the surface on which the furniture rests.

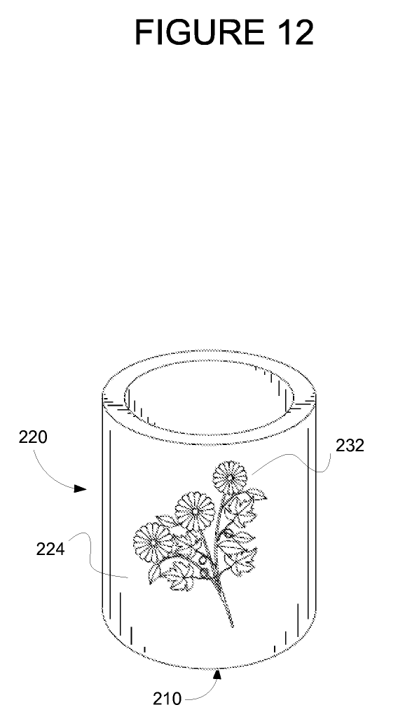

FIG. 12 is a perspective view of a protective guard for furniture legs, in accordance with an embodiment of the invention. In some embodiments, a protective guard for furniture legs has a decorative appearance. In such embodiments, an outside surface 224 of a cushion 220 can have a graphic design 232. Such a graphic design can provide a pleasing visual appeal to the protective guard for furniture legs. Further, a protective guard for furniture legs with a graphic design 232 can enhance the visual appeal of the furniture itself. In some embodiments, a graphic design 232 can include one or more various colors. In different embodiments, a graphic design 232 can include stars or other pattern. In some embodiments, a graphic design 232 is silk-screened onto the outside surface 224 of a cushion 220. In different embodiments, a graphic design 232 is carved into the outside surface 224 of a cushion 220. In yet a different embodiment, a graphic design 232 is constructed of material that is adhered to the outside surface 224 of a cushion 220. It will be appreciated by those with skill in the art that many possibilities for providing a graphic design 232 for a cushion 220 of a protective guard for furniture legs exist, and that enumerating them is beyond the scope of the instant application but that any within the grasp of those with skill in the art are hereby disclosed in the instant application.

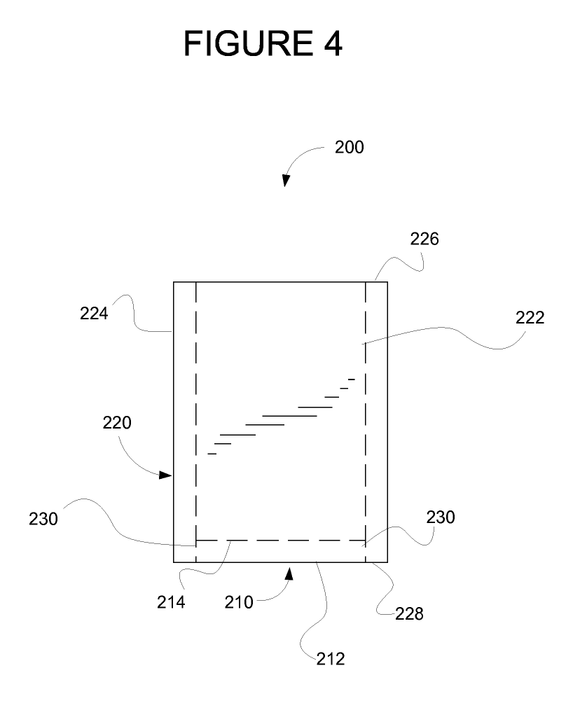

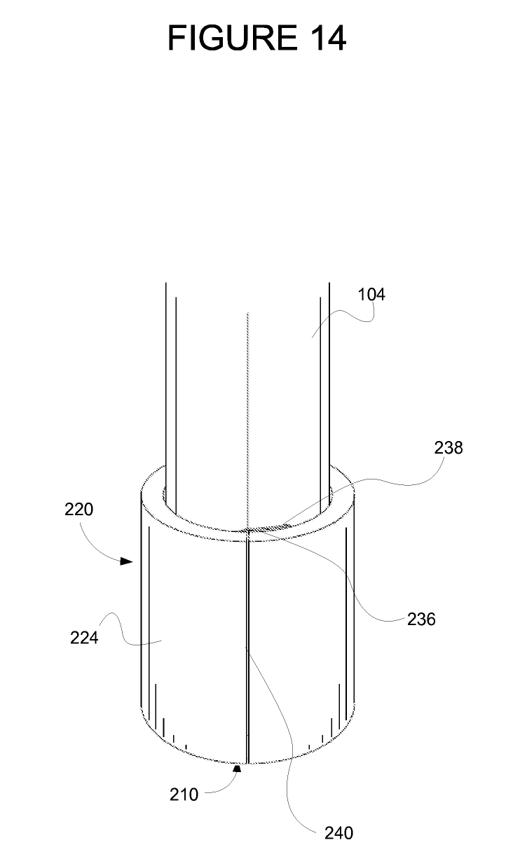

FIGS. 13-14 are perspective views of a protective guard for furniture legs, in accordance with embodiments of the invention. In some embodiments, a cushion 220 for a protective guard for furniture legs has an aperture 240, the aperture being disposed from a top edge 226 of the cushion 220 to the bottom edge 228 of the cushion 220. In such an embodiment, a joint 230 exists (not depicted in FIG. 13 or 14 but shown in FIG. 4) between the side wall 216 of the base 210 and a bottom portion 234 of the inside surface 222 of the cushion 220. In this embodiment, the joint 230 is disposed about at least a portion of the side wall 216 of the base 210. In some embodiments, the joint 230 is disposed about approximately 60% of the side wall 216 of the base 210, and the portions of the cushion 220 and base 210 that are joined at joint 230 are permanently joined using glue or another suitable adhesive. In such embodiments, providing an aperture 240 and only joining the cushion 220 to a portion of the base 210 provides a pull-apart function for a protective guard for furniture legs. When deploying this embodiment, a leg of a piece of furniture does not have to be raised as high off the surface on which the furniture rests in order for the embodiment to be deployed. In embodiments without an aperture in the cushion 220, the furniture must likely be raised at least as high as the height of the cushion 220. In one-piece embodiments with an aperture 240, a piece of furniture need only be raised slightly higher than the height of the base 210 for this embodiment of the protective guard for furniture legs to be deployed. Provided the furniture leg 104 is skinny enough to fit through the aperture 240 in the cushion 220 that is formed by pulling one or more portions of the cushion 220 away from the base 210, deployment of this embodiment requires the furniture to be lifted less.

In some embodiments, a protective guard for furniture legs with an aperture 240 has no additional apparatus to secure the “closure” of the one or more portions of the cushion 220 pulled away from the base 210 to dispose a furniture leg 104 through the cushion 220. In such an embodiment, the natural curve of the foam with which a protective guard for furniture legs may be constructed will, when the one or more portions of the cushion 220 that have been pulled away from the base 210 are released, return the cushion to its natural cylindrical form, with the entirety of the bottom portion 234 of the inside surface 222 of the cushion 220 disposed along the side wall 216 of the base 210.

In a different embodiment, a protective guard for furniture legs with an aperture 240 has a coupling device to secure the “closure” of the one or more portions of the cushion 220 pulled away from the base 210 to dispose a furniture leg 104 through the cushion 220. In some embodiments, the coupling device is a hook and loop type coupling device (e.g. Velcro® brand hook and loop fasteners). In a different embodiment, the coupling device is a zipper. It will be recognized by those with skill in the art that other coupling devices are possible and are within the scope of this disclosure.

In some embodiments, a protective guard for furniture legs with an aperture 240 uses a hook and loop type coupling device, wherein the hook portion 236 and the loop portion 238 of the hook and loop type coupling device are adhered to the inside surface 222 of the cushion 220, said hook portion 236 disposed along the aperture 240 along a first portion of the inside surface 222. In this embodiment, the loop portion 238 is disposed along the aperture 240 along a second portion of the inside surface 222. In this embodiment, the hook portion 236 and loop portion 238 are adhered to the inside surface 222 on opposite sides of the aperture 240. When the first portion and the second portion of the inside surface 222 are positioned adjacent to one another, “closing” the aperture 240 such that the bottom portion 234 of the inside surface 222 of the cushion 220 is disposed adjacent to the side wall 216 of the base 210, the hook portion 236 and loop portion 238 of the fastener can fasten together, holding the aperture 240 “closed.”

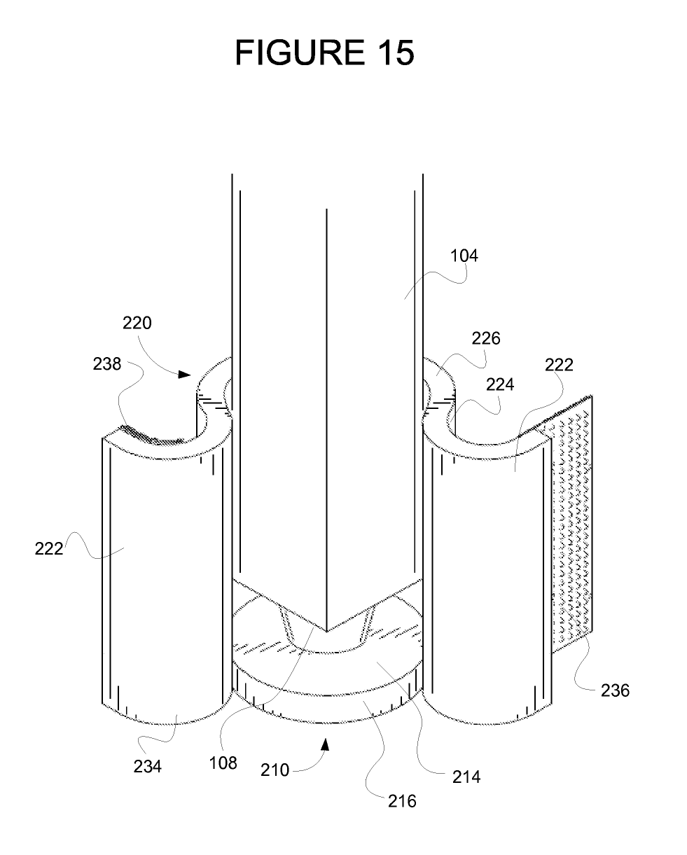

FIGS. 15-17 are perspective views of a protective guard for furniture legs, in accordance with embodiments of the invention.

In some embodiments, the coupling device to secure the “closure” of the one or more portions of the cushion 220 that can be pulled away from the base 210 is a hook and loop type coupling device that is disposed on the outside surface 224 of the cushion 220. In some embodiments, a protective guard for furniture legs with an aperture 240 has a hook portion 236 and a loop portion 238 of the hook and loop type coupling device that are adhered to the outside surface 224 of the cushion 220, said hook portion 236 disposed along the aperture 240 along a first portion of the outside surface 224. In this embodiment, the loop portion 238 is disposed along the aperture 240 along a second portion of the outside surface 224. In this embodiment, the hook portion 236 and loop portion 238 are adhered to the outside surface 224 on opposite sides of the aperture 240. When the first portion and the second portion of the outside surface 224 are positioned adjacent to one another, “closing” the aperture 240 such that the bottom portion 234 of the inside surface 222 of the cushion 220 is disposed adjacent to the side wall 216 of the base 210, the hook portion 236 and loop portion 238 of the fastener can fasten together, holding the aperture 240 “closed.”

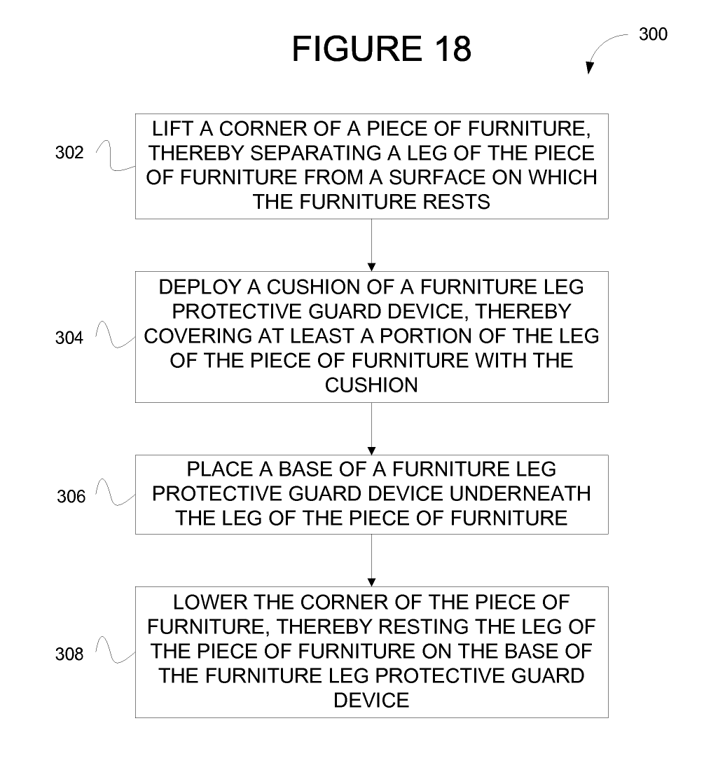

FIG. 18 is a flow diagram for a method of providing a protective guard for furniture legs, in accordance with an embodiment of the invention. Method 300 includes lifting a corner of a piece of furniture, thereby separating a leg of the piece of furniture from a surface on which the furniture rests 302; deploying a cushion of a furniture leg protective guard device, thereby covering at least a portion of the leg of the piece of furniture with the cushion 304; placing a base of a furniture leg protective guard device underneath the leg of the piece of furniture 306; and lowering the corner of the piece of furniture, thereby resting the leg of the piece of furniture on the base of the furniture leg protective guard device 308. Using this method, a protective guard for furniture legs can be installed on any leg disposed near a corner of a piece of furniture. It should be appreciated by those with skill in the art that the method can be used with legs that are disposed other than near a corner of a piece of furniture. It should also be appreciated by those with skill in the art that the method can be practiced with a furniture leg protective guard device that includes a base and cushion as separate components, or with a furniture leg protective guard device where the base and cushion are integrated into a one-piece furniture leg protective guard device. When the method is used with a one-piece furniture leg protective guard device, at 304 a person using the method will deploy the cushion by sliding it over the leg at the base of the leg. While holding the bed in a raised position, at 306 a person will then center the one-piece device such that the center of the bottom edge of the leg is disposed over the center of the base of the furniture leg protective guard device. At that time, at 308 the piece of furniture can be lowered onto the device, with the cushion portion covering at least a portion of the leg of the piece of furniture. It will be further appreciated by those with skill in the art that when an embodiment of a furniture leg protective guard device having an aperture in the cushion is used, at 302 the bed will not need to be lifted as high to slide the base of the device underneath the leg of the bed.

While preferred and alternative embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

### APPENDIX—INVENTOR DISCLOSURE

### BED FOOTIES

### INVENTOR—JULIE WILLIS

### JUN. 18, 2011

### PURPOSE

Bed Footies serve 4 purposes
   1. Covers wheels and legs of bed frame to prevent injury to foot or toes while making bed.
   2. Prevents bed from rolling by having a cushioned base under the wheel.
   3. Helps protect flooring from scratches and damage caused by the weight and movement of bed.
   4. Covers wheels and legs of bed frame with a decorative cover.

### DESIGN

Bed Footies are designed similar to a beverage koozie. They are cylinders that have an exterior radius of approximately 3½ inches and an interior radius of approximately 2⅝ inches, are 4 to 7 inches tall and are made of foam rubber or neoprene. There is a circular base that has a radius of 2⅝ inches that is separate. The circular base sits under the bed frame foot or wheel. The cylinder covers the wheel and leg of a bed frame as well as the circular base.

What is claimed is:

1. A furniture leg protective guard device, comprising:
a base on which a furniture leg rests; and
a cushion covering at least a portion of the furniture leg.

2. The furniture leg protective guard device of claim 1, wherein the base on which a furniture leg rests is a circular base on which a furniture leg rests, the circular base on which a furniture leg rests having:
a bottom surface that is substantially flat;
a top surface that is substantially flat; and
a side wall that is largely cylindrical.

3. The furniture leg protective guard device of claim 2, wherein the cushion covering at least a portion of the furniture leg is a cylindrical cushion covering at least a portion of the furniture leg, the cylindrical cushion covering at least a portion of the furniture leg having:
a cylindrical inside surface;
a cylindrical outside surface;
a substantially flat top edge; and
a substantially flat bottom edge.

4. The furniture leg protective guard device of claim 3, wherein the cylindrical cushion covering at least a portion of the furniture leg has an aperture disposed from the top edge of the cylindrical cushion to the bottom edge of the cylindrical cushion, said aperture extending through the cylindrical inside surface of the cylindrical cushion, said aperture extending through the cylindrical outside surface of the cylindrical cushion.

5. The furniture leg protective guard device of claim 4, wherein the cylindrical cushion covering at least a portion of the furniture leg has a coupling device, wherein said coupling device closes the aperture disposed from the top edge of the cylindrical cushion to the bottom edge of the cylindrical cushion.

6. The furniture leg protective guard device of claim 3, wherein at least a portion of the circular base on which a furniture leg rests joins the cushion covering at least a portion of the furniture leg at a joint, said joint disposed about at least a portion of the side wall of the circular base, said joint disposed along the inside surface of the cylindrical cushion at a bottom portion of the cylindrical cushion, such that the bottom surface of the circular base and the bottom edge of the cylindrical cushion form a plane.

7. The furniture leg protective guard device of claim 6, wherein the circular base on which a furniture leg rests and the cylindrical cushion covering at least a portion of the furniture leg are made of foam rubber or neoprene.

8. The furniture leg protective guard device of claim 6, wherein the circular base on which a furniture leg rests has a radius of approximately two and five eighths inches.

9. The furniture leg protective guard device of claim 6, wherein the cylindrical cushion covering at least a portion of the furniture leg has a height measured from the top edge of the cylindrical cushion to the bottom edge of the cylindrical cushion of approximately three and one half inches.

10. The furniture leg protective guard device of claim 6, wherein the cylindrical cushion covering at least a portion of the furniture leg has an exterior radius of approximately three and one half inches and an interior radius of approximately two and five eights inches.

11. The furniture leg protective guard device of claim 6, wherein the cylindrical cushion covering at least a portion of the furniture leg has a thickness measured between the cylindrical inside surface and the cylindrical outside surface of approximately seven eighths of an inch.

12. The furniture leg protective guard device of claim 6, wherein the circular base on which a furniture leg rests has a thickness measured between the bottom surface of the circular base and the top surface of the cylindrical base of approximately seven eighths of an inch.

13. The furniture leg protective guard device of claim 6, wherein the at least a portion of a furniture leg is at least a portion of a bed leg.

14. A furniture leg protective guard device, comprising:
a circular base on which a furniture leg rests, the circular base on which a furniture leg rests including:
a bottom surface that is substantially flat;
a top surface that is substantially flat; and
a side wall that is largely cylindrical; and
a cylindrical cushion covering at least a portion of a furniture leg, the cylindrical cushion covering at least a portion of a furniture leg including:
a cylindrical inside surface;
a cylindrical outside surface;
a substantially flat top edge; and
a substantially flat bottom edge;
wherein at least a portion of the circular base on which a furniture leg rests joins the cushion covering at least a portion of the furniture leg at a joint, said joint disposed about at least a portion of the side wall of the circular base, said joint disposed along the inside surface of the cylindrical cushion at a bottom portion of the cylindrical cushion, such that the bottom surface of the circular base and the bottom edge of the cylindrical cushion form a plane, and wherein the circular base on which a furniture leg rests and the cylindrical cushion covering at least a portion of the furniture leg are made of foam rubber or neoprene, and wherein the circular base on which a furniture leg rests has a radius of approximately two and five eighths inches and a thickness measured between the bottom surface of the circular base and the top surface of the cylindrical base of approximately seven eighths of an inch, and wherein the cylindrical cushion covering at least a portion of the furniture leg has a height measured from the top edge of the cylindrical cushion to the bottom edge of the cylindrical cushion of approximately three and one half inches and an exterior radius of approximately three and one half inches and an interior radius of approximately two and five eights inches and a thickness measured between the cylindrical inside surface and the cylindrical outside surface of approximately seven eighths of an inch, and wherein the at least a portion of a furniture leg is at least a portion of a bed leg.

15. A method, comprising the steps of:
lifting a corner of a piece of furniture, thereby separating a leg of the piece of furniture from a surface on which the furniture rests;
deploying a cushion of a furniture leg protective guard device, thereby covering at least a portion of the leg of the piece of furniture with the cushion;
placing a base of a furniture leg protective guard device underneath the leg of the piece of furniture; and
lowering the corner of the piece of furniture, thereby resting the leg of the piece of furniture on the base of the furniture leg protective guard device.
